(19) United States
(12) Patent Application Publication
(10) Pub. No.: US 2020/0047951 A1
(43) Pub. Date: Feb. 13, 2020

(54) VOMIT BAG WITH LID

(71) Applicant: Jennifer Kamman Linn, Kingwood, TX (US)

(72) Inventor: Jennifer Kamman Linn, Kingwood, TX (US)

(21) Appl. No.: 16/538,758

(22) Filed: Aug. 12, 2019

Related U.S. Application Data
(60) Provisional application No. 62/717,447, filed on Aug. 10, 2018.

(51) Int. Cl. B65D 33/16; B65D 21/02; A61J 19/00; B65D 55/16

(52) U.S. Cl. CPC B65D 33/16; B65D 55/16; A61J 19/00; B65D 21/0233

(57) ABSTRACT

The emesis or vomit bag includes a lid assembly with a lid and a rim member. The lid is coupled to the rim member and is configured to seat within a portion of the rim member so as to create a seal. The bag is coupled to the lid assembly so as to define an internal volume. The internal volume is configured to be sealed as the lid is seated in the rim member. It is preferred that the bag is heat welded to a perimeter of the lid assembly to ensure it is fully sealed thereto. The bag may be of various sizes including a volume of at least 1090 ml. The bag is collapsible within an interior of the rim member. The lid assembly may be tapered and stacked within the recess of a neighboring lid when seated in its own rim member.

### CLAIM OF PRIORITY

This application claims the benefit of U.S. Provisional Application No. 62/717,447, filed 10 Aug. 2018. The information contained therein is hereby incorporated by reference.

### BACKGROUND

### 1. Field of the Invention

The present application relates generally to an emesis bag for the collection of human fluid.

### 2. Description of Related Art

Illnesses beset all people at some point. Nausea is a common symptom and can result from any number of illnesses. Nausea often invokes a bodily response where a person vomits up contents from the stomach. As noted, this can be caused by an illness, but also this may be a result of motion sickness. It is common that people tend to capture the vomit in a container of some type to allow for later disposal. These containers are typically open top containers without a means of sealing the vomit contents therein. Spillage can occur and the smell of vomit can induce bad responses from those around it.

Although great strides have been made with respect to vomit containers, considerable shortcomings remain. A new vomit bag is needed that is easily transportable and compact to maintain a level of discreteness. The bag is to include a means of sealing its opening to prevent spillage.

### SUMMARY OF THE INVENTION

It is an object of the present application to provide an emesis or vomit bag having a lid assembly with a lid and a rim member. The lid is coupled to the rim member and is configured to seat within a portion of the rim member so as to create a seal. The bag is coupled to the lid assembly so as to define an internal volume. The internal volume is configured to be sealed as the lid is seated in the rim member. It is preferred that the bag is heat welded to a perimeter of the lid assembly to ensure it is fully sealed thereto. The bag may be of various sizes including a volume of at least 1090 ml.

The lid operates between an open and closed configuration and is also sealable to the rim member along an internal rib via interference fit. The sealing of the lid to the rim member prevents the passage of any of gas, liquid, and solids out of the bag. A tether may be included and is configured to maintain the lid in proximity to the rim member. In some configurations it is flexible.

One object of the present application is to provide a vomit bag that is also collapsible for ease of storage and transportation. The bag of the present application is collapsible so as to be stored within an interior of the rim member, typically within a skirt area of the rim member. Therefore, the lid assembly may be tapered and stacked within the recess of a neighboring lid when seated in its own rim member.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a vomit bag with lid according to an embodiment of the present application.

FIG. 2 is an alternate perspective view of the vomit bag with lid of FIG. 1.

FIG. 3 is a top view of the vomit bag with lid of FIG. 2.

FIG. 4 is a side view of a lid assembly in the vomit bag with lid of FIG. 1.

FIG. 5 is a section view through the lid assembly of FIG. 4.

FIG. 6 is a perspective view of a bag in the vomit bag with lid of FIG. 1.

FIGS. 7 and 8 are views of the vomit bag with lid of FIG. 1 nestled for storage within one another.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The system and method in accordance with the present application overcomes one or more of the above-discussed problems commonly associated with conventional emesis bags. Specifically, the vomit bag with lid of the present application is configured to include a sealable lid that selectively opens and closes so as to limit the discharge of vomit from within the bag. The bag is collapsible so as to tuck within the lid. These and other unique features of the device are discussed below and illustrated in the accompanying drawings.

The system and method will be understood as to its operation, from the accompanying drawings, taken in conjunction with the accompanying description. It should be understood that various components, parts, and features of the device may be combined together and/or interchanged with one another, all of which are within the scope of the present application, even though not all variations and particular embodiments are shown in the drawings. It should also be understood that the mixing and matching of features, elements, and/or functions is expressly contemplated herein so that one of ordinary skill in the art would appreciate from this disclosure that the features, elements, and/or functions of one embodiment may be incorporated into another embodiment as appropriate, unless otherwise described.

The system and method of the present application includes a lid assembly that opens and closes. A bag is also included in communication with a lower portion of the lid assembly. The lid within the lid assembly is coupled to a rim member. The bag is also coupled to the rim member. Additional features and functions of the device are illustrated and discussed below.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

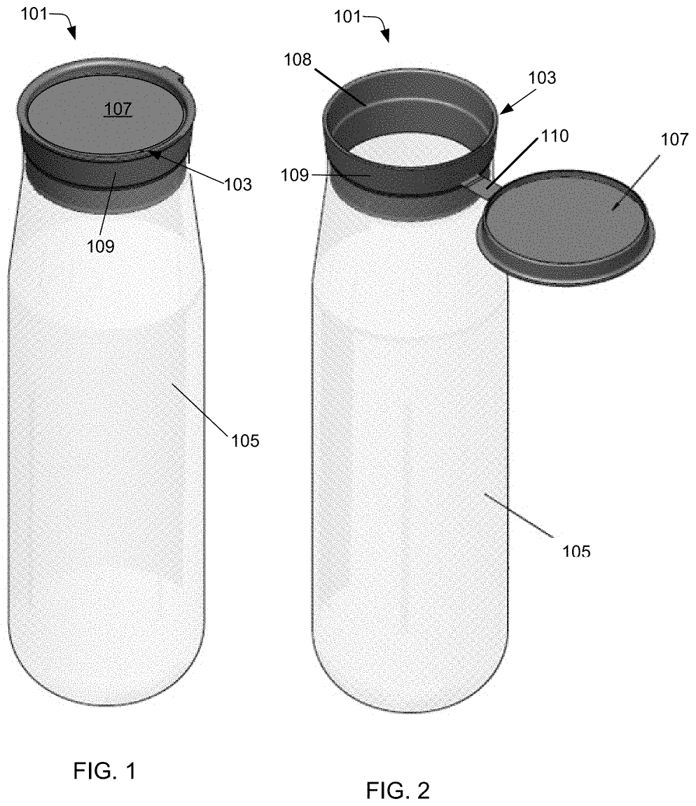

Referring now to FIGS. 1 and 2 in the drawings, perspective views of a vomit bag with lid assembly is shown. The vomit bag 101 includes a lid assembly 103 and a bag 105. The lid assembly 103 is configured to operate between an open and closed orientation. A lid 107 in the assembly 103 is coupled to a rim member 109. Rim member 109 defines an outer perimeter of assembly 103. Rim member 109 has an inner and outer surface wherein the inner surface is profiled so as to include at least one rib 108 for seating lid 107. Lid 107 is pivotally coupled to rim member 109 through tether 111. Lid 107 is configured to translate partially within member 109 so as to slide adjacent its inner surface so as to seat itself therein. Lid 107 is configured to seat within and along the inner surface of rim member 109 so as to create a seal. The seal created is sufficient to prevent the passage of liquids, solids, and gases, from bag 105 through the opening of member 109.

It should be understood that tether 111 is merely one embodiment of a tether or attachment that links lid 107 to rim member 109. The embodiment is not herein limited to this configuration. Tether 111 is any tethering device that is suitable to prevent the loss of lid 107 while permitting the repositioning of lid 107 relative to rim member 109. As seen in FIGS. 1 and 2, lid 107 is shown in a closed and open configuration, respectively.

Furthermore, the location of tether 111 may be done at any location on the outer surface of assembly 103. In this case, the tether 111 is performed by a plastic flap. In operation, the lid is selectively folded over and into the upper aperture of member 109. Lid 107 has a slightly smaller diameter so as to fit within the aperture. Tolerances are such that a seal is created.

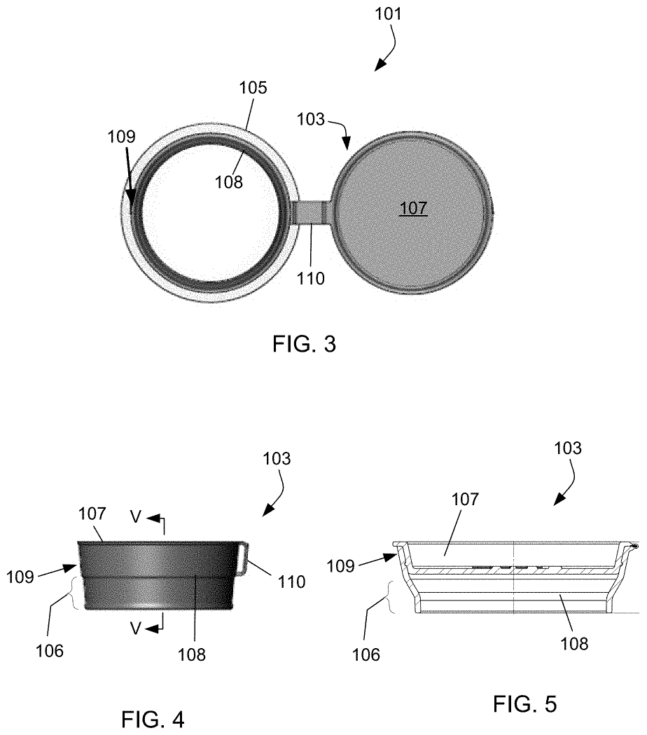

Referring now also to FIG. 3 in the drawings, a top view of vomit bag 101 is illustrated. In this view, lid assembly 103 is in an open configuration similar to FIG. 2.

Referring now also to FIGS. 4 and 5 in the drawings, a side view of lid assembly 103 is illustrated in FIG. 4 and a section view of lid assembly 103 is illustrated in FIG. 5. In FIG. 4, the lid assembly from FIG. 1 is shown wherein lid 107 is in a closed configuration. Lid 107 is fully seated within rim member 109 wherein most of lid 107 is sunken therein. Lid 107 is configured to recess within the perimeter and create a seal to prevent the passage of fluid. Lid 107 passes within member 109 until rib 108. Rib 108 is seen on the outer surface of member 109.

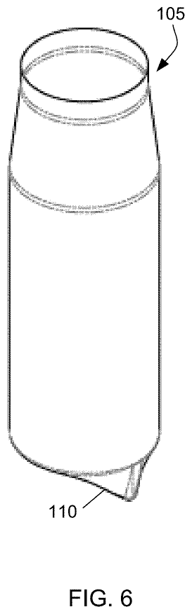

Referring now also to FIG. 6 in the drawings, a perspective view of bag 105 is illustrated. Bag 105 is configured to hang down from assembly 103. Bag 105 connects around the outer surface perimeter of rim member 109 and defines an internal volume for the acceptance of vomit. Bag 105 is coupled to lower skirt 106 of member 109. One manner in which the coupling may occur is through heat welding of the bag 105 to rim member 109 just below rib 108. Other options are possible and vomit bag 101 is not herein meant to be limited to this particular method of securing bag 105 to assembly 103. Of importance is that a seal is created between the two components to prevent leakage of liquids, gases, and solids.

At the top of the bag 105 is an opening to match the aperture of lid assembly 103. The top portion is slightly tapered and shaped to match up with the outer perimeter of skirt 106. As noted previously, bag 105 is ideally heat welded to the lid assembly 103 just under the rib 108 of the rim member 109. The internal volume of bag 105 can vary depending on size and use but an exemplary internal volume could be approximately 1090 ML. At the base of bag 105, the bag material may be bunched together to form a tapered bottom 110. The material may be further heat welded here.

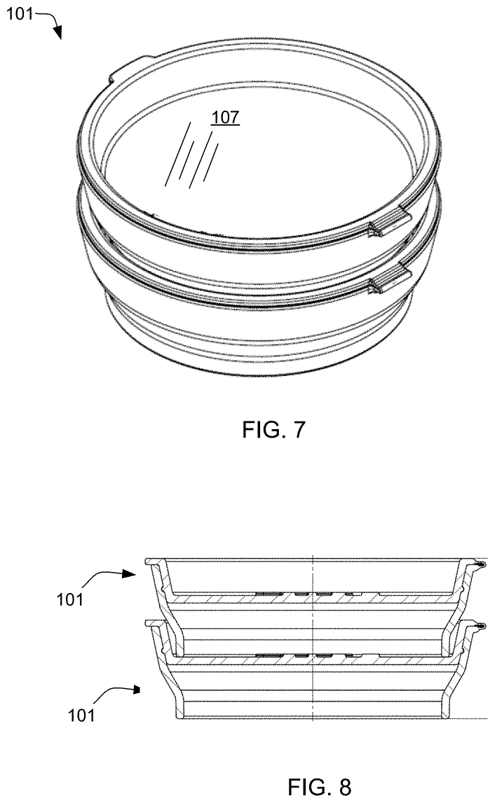

Referring now also to FIGS. 7 and 8 in the drawings, views of vomit bag 101 are shown in a stacked configuration. Vomit bag 101 is configured to collapse and nestle within itself for ease of storage. As seen in the figures, lid 107 is recessed down into member 109. A second vomit bag 101 may then rest within this recess (see FIG. 8). Bag 105 is configured to compress and fold up into the interior to assembly 103 within skirt 106. In use, a person is able to grasp vomit bag 101, open the lid and extend bag 105. A person that feels ill may vomit into the bag by putting their mouth near the upper aperture. The contents will be held in the bag. The person may then close the interior volume to prevent liquid from escaping. Additionally, the closure of the lid may stop the dissemination of the smell of vomit.

Particular advantages of vomit bag 101 include at least the following: (1) sealable lid to prevent spillage of liquid from the bag; and (2) trapping contents inside the bag.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An emesis bag, comprising:
a lid assembly having a lid and a rim member, the lid is coupled to the rim member and is configured to seat within a portion of the rim member so as to create a seal; and
a bag coupled to the lid assembly so as to define an internal volume, the internal volume configured to be sealed as the lid is seated in the rim member.

2. The emesis bag of claim 1, wherein the bag is heat welded to a perimeter of the lid assembly.

3. The emesis bag of claim 1, wherein the bag is sealed to the lid assembly.

4. The emesis bag of claim 1, wherein the bag has a volume of at least 1090 ml.

5. The emesis bag of claim 1, wherein the sealing of the lid to the rim member prevents the passage of any of gas, liquid, and solids out of the bag.

6. The emesis bag of claim 1, further comprising:
a tether configured to maintain the lid in proximity to the rim member.

7. The emesis bag of claim 6, wherein the tether is flexible.

8. The emesis bag of claim 1, wherein the rim member includes a rib.

9. The emesis bag of claim 1, wherein the bag is collapsible so as to be stored within an interior of the rim member.

10. The emesis bag of claim 1, wherein the lid assembly is configured to selectively nestle in a stacked configuration.

11. The emesis bag of claim 1, wherein the lid is recessed within the rim member when in a closed configuration.

12. An emesis bag, comprising:
a lid assembly having a lid and a rim member coupled together via a tether, the lid is configured to seat internally to and recess within the rim member, the lid is configured to translate within the rim member and create a seal when seated, the lid configured to operate between an open configuration and a closed configuration; and
a bag coupled to an outer surface of the rim member via a heat weld process, the bag defining an internal volume, the internal volume configured to be sealed from as the lid is seated in the rim member.

13. The emesis bag of claim 12, wherein the bag is sealed to the lid assembly.

14. The emesis bag of claim 12, wherein the bag has a volume of at least 1090 ml.

15. The emesis bag of claim 12, wherein the sealing of the lid to the rim member prevents the passage of any of gas, liquid, and solids out of the bag.

16. The emesis bag of claim 12, wherein the rim member includes a rib.

17. The emesis bag of claim 12, wherein the bag is collapsible so as to be stored within an interior of the rim member.

18. The emesis bag of claim 12, wherein the lid assembly is configured to selectively nestle in a stacked configuration.
